(19) United States
(12) Patent Application Publication
(10) Pub. No.: US 2005/0264207 A1
(43) Pub. Date: Dec. 1, 2005

(54) Plasma display panel and method of preparing the same

(76) Inventors: Tae-Kyoung Kang, Suwon-si (KR); Sung-Yong Lee, Suwon-si (KR); Seung-Uk Kwon, Suwon-si (KR); Jae-Ik Kwon, Suwon-si (KR); Seung-Beom Seo, Suwon-si (KR)

Correspondence Address: MCGUIREWOODS, LLP, 1750 TYSONS BLVD, SUITE 1800, MCLEAN, VA, 22102, US

(21) Appl. No.: 11/130,101

(22) Filed: May 17, 2005

(30) Foreign Application Priority Data
May 18, 2004 (KR) 10-2004-0035130

(51) Int. Cl. H01J 17/49; H01J 9/26

(52) U.S. Cl. 313/586; 313/587; 313/582; 445/25

(57) ABSTRACT

The present invention relates to a plasma display panel including a first substrate having a plurality of address electrodes and a dielectric layer, a second substrate, which is opposed to the first substrate, having a plurality of display electrodes, a dielectric layer, and a protection layer, barrier ribs formed on the first substrate to partition a plurality of discharge cells between the first substrate and the second substrate, a red, a green, and a blue phosphor layer formed inside of each discharge cell partitioned by the barrier ribs, and a layer for decreasing reflective brightness, which is formed on the upper-end surface of the barrier ribs, and comprises calcium magnesium silicate based blue phosphor.

### CROSS REFERENCE TO RELATED APPLICATION

This application claims prior to and the benefit of Korean Patent Application No. 10-2004-0035130 filed on May 18, 2004, which is hereby incorporated by reference for all purposes as if fully set forth herein

### BACKGROUND OF THE INVENTION

1. Field of the Invention

The present invention relates to a plasma display panel and a method of preparing the same, and more particularly to a plasma display panel capable of improving image quality by decreasing reflections at barrier ribs, and a method for preparing the same.

2. Description of the Related Art

A plasma display panel is a display device using a plasma, referred as a gas discharge phenomenon, in which a discharge occurs when a potential that is greater than a predetermined level is applied between two contact points with a space therebetween.

The plasma display panel is a flat display element using gas discharge to display an image. A common plasma display panel is, for example, a reflective AC (alternative current) plasma display panel having a discharge cell that is partitioned by barrier ribs and a phosphor layer that is coated inside the discharge cell.

The reflective AC plasma display panel, similar to other flat panel display devices such as a vacuum fluorescent display (VFD) or a field emission display (FED), includes two parallel substrates, referred as “a first substrate” and “a second substrate”, with a predetermined amount of space provided therebetween. The two parallel substrates are sealed with a sealing material around the perimeter thereof to provide a vacuum discharge cell.

A screen printing technique is commonly used for coating a phosphor layer in the plasma display panel; however, it is difficult to ensure the quality of a high definition (HD) level panel or a multi-panel acquisition process when using such technique. In particular, it is difficult and costly to prepare a print mask due to the short life of the print mask in a multi-panel acquisition process.

A nozzle spraying method, also referred to as a “dispenser method” has been suggested and may be use to replace the screen printing method. The dispenser method includes providing a nozzle for supplying or spraying a plurality of red, green, and blue phosphors between barrier ribs, which are finely spaced, and spraying each phosphor through the nozzle. The dispenser method increases the life span of the sprayer relative to the screen printing method. Further, the dispenser method may be used to apply a fine pattern in the panel and may also be used for multi-panel acquisition processes.

Although the dispenser method may be applied to a panel having stripe-type barrier ribs without defects, problems may occur when the dispenser method is applied to a panel having a closed type of barrier ribs because the phosphor layer is already coated on the upper-end surface of the barrier rib. In particular, a barium magnesium aluminate (BAM) based blue phosphor, which is commonly used as a phosphor layer, has a high reflectivity and causes problems when it is sprayed between the barrier ribs because it increases the reflective brightness of the whole panel when it is on the upper-end surface of the barrier rib.

### SUMMARY OF THE INVENTION

The invention provides a plasma display panel in which the upper-end of the barrier ribs is coated with a layer for decreasing a reflective brightness.

According to an embodiment of the invention, there is provided a plasma display panel including a first substrate having a plurality of address electrodes and a dielectric layer, a second substrate, which is opposed to the first substrate, having a plurality of display electrodes, a dielectric layer, and a protection layer, barrier ribs formed on the first substrate to partition a plurality of discharge cells between the first substrate and the second substrate, a red, a green, and a blue phosphor layer formed inside of the discharge cell partitioned by the barrier ribs, and a layer for decreasing reflective brightness, which is formed on the upper-end surface of the barrier ribs, and comprises calcium magnesium silicate based blue phosphor.

According to another embodiment of the invention, there is provided a method of fabricating a plasma display panel, including preparing a first substrate formed having a plurality of address electrodes and a dielectric layer, forming barrier ribs on the front surface of the dielectric layer of the first substrate to partition a plurality of discharge cells, forming a red, a green, and a blue phosphor layer inside of the discharge cell partitioned by the barrier ribs, forming a layer for decreasing reflective brightness on an upper-end of the barrier ribs, preparing a second substrate having a display electrodes, a dielectric layer, and a protection layer, and associating a panel with the first substrate and the second substrate and performing fabrication processes with the panel associated with the first and second substrates.

According to another embodiment of the invention, there is provided a method of reducing a reflective brightness of discharge cells formed on a substrate for a plasma display panel, including forming barrier ribs on the substrate to partition the discharge cells, and applying a substance for decreasing reflective brightness on a surface of the barrier ribs that is furthest from the substrate on which the barrier ribs are formed, wherein the substance for decreasing reflective brightness is formed having a same composition a blue phosphor layer previously provided on the discharge cells.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial perspective view showing an embodiment of the plasma display panel according to the invention.

FIG. 2 is a schematic view showing a process of measuring the reflective brightness of the plasma display panel.

FIG. 3 is a graph comparing the refractive brightness of the plasma display panel according to Comparative Example 1 and Examples 1 through 9 depending upon thickness.

FIG. 4 is a graph comparing the refractive brightness of the plasma display panel according to Comparative Example 1 and Examples 10 through 18 depending upon the thickness.

FIG. 5 is a graph comparing the refractive brightness of the plasma display panel according to Comparative Example 1 and Examples 19 through 27 depending upon the thickness.

### DETAILED DESCRIPTION OF THE PREFERRED EMBODIMENTS

Embodiments of the present invention will now be described in detail with reference to the accompanying drawings.

According to an embodiment of the invention, there is provided a plasma display panel that includes a first substrate and a second substrate facing the first substrate. The first substrate has a plurality of address electrodes and a dielectric layer formed thereon. The second substrate has a plurality of display electrodes, a dielectric layer, and a protection layer formed thereon. Barrier ribs are formed on the first substrate to partition a plurality of discharge cells in the space between the first substrate and the second substrate. A red, green, and blue phosphor layers are formed inside of the discharge cell partitioned by the barrier ribs. A layer for decreasing a reflective brightness is applied to or provided on an upper end surface of the barrier ribs, the layer includes a calcium magnesium silicate (CMS) based blue phosphor.

According to another embodiment of the invention, there is provided a method of fabricating a plasma display panel that includes preparing a first substrate formed with a plurality of address electrodes and a dielectric layer, forming barrier ribs on a front surface of the dielectric layer of the first substrate to partition a plurality of discharge cells, forming a red, green, and blue phosphor layer inside of the discharge cell partitioned by the barrier ribs and forming a layer for decreasing a reflective brightness on an upper-end of the barrier ribs, preparing a second substrate formed with display electrodes, a dielectric layer and a protection layer, and associating a panel with the first substrate and the second substrate, then sealing, evaporating, injecting a discharge gas, and aging the associated panel.

The plasma display panel of the invention improves the refractive brightness by including a layer for decreasing the refractive brightness on the upper-end surface of the barrier rib.

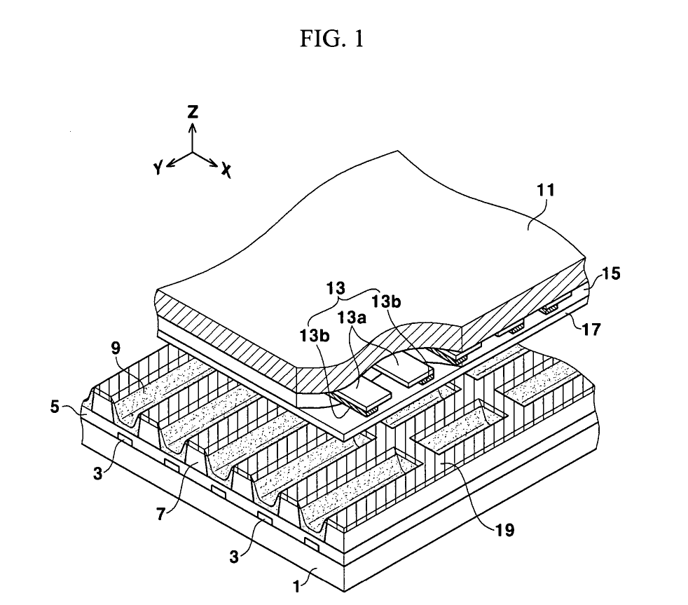

FIG. 1 is a partial perspective view showing an embodiment of the plasma display panel according to a non-limiting example of the invention. Referring to FIG. 1, the first substrate 1 of the plasma display panel includes address electrodes 3 formed, provided, or located along a certain direction (direction Y in the FIG. 1), and a dielectric layer 5 is provided on a front surface of the first substrate 1 and over the address electrodes 3. Barrier ribs 7 are provided on the dielectric layer 5, and red (R), green (G), and blue (B) phosphor layers 9 are positioned or provided on a discharge cell between the barrier ribs 7. A layer for decreasing reflective brightness 19 is provided on an upper-end (top side) of the barrier ribs 7.

On a surface of a second substrate 11 facing the first substrate 1, display electrodes 13 are provided in a substantially perpendicular or opposite direction to a direction of the address electrodes 3 provided on the first substrate. Each of the display electrodes 13 include a transparent electrode 13a and a bus electrode 13b. A transparent dielectric layer 15 and a protection layer 17 are provided on an entire surface of the second substrate 11 and cover the display electrodes 13. According to the above described embodiment, a discharge cell is formed based on the cross section of the address electrode 3 and the display electrode 13.

A cell is addressed by applying an address voltage Va between the address electrode 3 and a particular display electrode 13. Further, when a sustain voltage Vs is applied between a pair of display electrodes 13, a vacuum ultraviolet ray generated by the sustain discharge excites a corresponding phosphor layer 9 to emit a visible light though a transparent front surface of the second substrate 11.

According to an embodiment of the invention, the plasma display panel includes barrier ribs 7, such as striped barrier ribs or closed-type barrier ribs. On the upper-end of the barrier ribs 7, e.g., a surface of the barrier ribs nearest to the transparent front surface of the second substrate 11, a layer is provided or coated thereon for decreasing a reflective brightness comprising calcium magnesium silicate (CMS) based blue phosphor.

It is understood that the layer for decreasing a reflective brightness may be applied or coated on an entire surface of the upper-end surface of the barrier ribs 7 or a portion of the upper-end surface of the barrier ribs 7. In particular, when the plasma display panel includes the closed type barrier ribs, the layer may be coated only on horizontal barrier ribs provided perpendicular to the address electrode or, instead, the layer may be coated only on the upper-end surface of the horizontal barrier ribs between the blue cells.

For example, the upper-end surface of the barrier rib 7 may be coated with a layer for decreasing a reflective brightness to approximately 2 to 20 μm thick, and more preferably a thickness of 6 to 20 μm thick. When the upper-end surface is coated less than approximately 2 μm thick, such coating is not sufficient to decrease the refractive brightness to a satisfactory level. When the upper-end surface is coated thicker than approximately 20 μm, an error discharge may occur.

According to an embodiment of the invention, the layer for decreasing a reflective brightness includes approximately 50 to 100% by weight of calcium magnesium silicate (CMS) based blue phosphor. The layer for decreasing the reflective brightness may further include a barium magnesium aluminate (BAM) based blue phosphor. When the amount of the calcium magnesium silicate based blue phosphor is less than approximately 50% by weight, such coating is not sufficient to decrease the refractive brightness to a satisfactory level.

According to an embodiment of the invention, a method for fabricating the plasma display panel includes forming a plurality of address electrodes 3 and a dielectric layer 5 on a first substrate 1. Barrier ribs 7 are formed on a front surface of the dielectric layer 5 of the first substrate 1 to partition a plurality of discharge cells. A red phosphor layer, a green phosphor layer, and a blue phosphor layer are formed inside of the discharge cell partitioned by the barrier ribs 7. A layer is formed on the upper-end of the barrier ribs 7, e.g., a surface nearest to the second substrate 11, for decreasing a reflective brightness. A second substrate 11 is provided with a plurality of display electrodes 13, a dielectric layer 5 and a protection layer 17. the first substrate is subsequently associated the second substrate, then the associated panel is sealed, evaporated, injected with a discharge gas, and aged for a period of time.

Hereinafter, the method for forming the phosphor layer and the layer for decreasing the reflective brightness are described in detail. Several of the methods of fabricating the plasma display panel described briefly above, such as preparing a first substrate formed with a plurality of address electrodes and a dielectric layer; forming barrier ribs on the front surface of the dielectric layer of the first substrate to partition a plurality of discharge cells; preparing a second substrate formed with display electrodes, a dielectric layer, and a protective layer; and associating a panel with the first substrate and the second substrate, then sealing, evaporating, injecting a discharge gas, and aging the same, are omitted from the discussion below for purposes of convenience because such methods are already known to those skilled in the art.

The phosphor layer and the layer for decreasing a reflective brightness may be formed according to a dispenser technique in a single operation. On the other hand, the phosphor layer and the layer for decreasing a reflective brightness may be formed by multiple operations, for example, the phosphor layer may be formed inside of the discharge cell according to a screen printing technique or the dispenser technique, and the layer for decreasing a reflective brightness may subsequently be formed on the upper-end surface of barrier ribs 7 according to the dispenser technique. It is preferable, but not essential, that a composition of the blue phosphor layer is the same or substantially the same as a composition of the layer provided for decreasing the reflective brightness when the phosphor layer and the layer for decreasing the reflective brightness are simultaneously formed.

The plasma display panel may further include striped barrier ribs or closed-type barrier ribs. A layer of calcium magnesium silicate (CMS) based blue phosphor is coated or provided on the upper-end of the barrier ribs 7 to decrease the reflective brightness.

Alternatively, the layer for decreasing the reflective brightness may be coated or provided on an entire area of the upper-end surface of the barrier ribs 7 or a portion of the upper-end surface of the barrier ribs 7. Specifically, when the closed type barrier ribs are coated, the layer may be coated or provided only on horizontal barrier ribs that are perpendicular to the address electrodes 3 or the layer may be coated or provided only on the upper-end surface of the horizontal barrier ribs provided between the blue cells.

For example, the upper-end surface of the barrier ribs 7 may be coated with a layer for decreasing a reflective brightness to approximately 2 to 20 μm thick, and more preferably to 6 to 20 μm thick. When the upper-end surface is coated less than approximately 2 μm thick, such coating is not sufficient to decrease the refractive brightness to a satisfactory level. When the upper-end surface is coated thicker than approximately 20 μm, an error discharge may occur.

According to an embodiment of the invention, the layer for decreasing a reflective brightness includes approximately 50 to 100% by weight of calcium magnesium silicate (CMS) based blue phosphor. The layer for decreasing the reflective brightness may further comprise barium magnesium aluminate (BAM) based blue phosphor. When the amount of the CMS blue phosphor is less than approximately 50% by weight, such coating is not sufficient to decrease the reflective brightness to a satisfactory level. Several embodiments and examples of the invention are described in detail here below. However, it is understood that the present invention is not limited by these embodiments or examples.

### COMPARATIVE EXAMPLE 1

According to an embodiment of the invention, a binder solution is provided by adding 6 parts by weight of a binder of ethyl cellulose to 100 parts by weight of a mixed solvent of butyl carbitol acetate and terpineol (weight ratio of 4:6). 40 parts by weight of each of a blue phosphor of BaMgAl₁₀O₁₇:Eu, a red phosphor of (Y,Gd)BO₃:Eu, and a green phosphor of ZnSiO₄:Mn are added to the 100 parts by weight of the resulting binder solution and mixed, respectively. The resulting red, green, and blue phosphors mixture is coated inside of discharge cells partitioned by closed-type barrier ribs according to, for example, a screen printing process to provide a phosphor layer on the first substrate.

A display electrode 13, a dielectric layer 5, and a protection layer 17 are provided on the second substrate 11. The resulting first and second substrates 11 are associated, sealed, evaporated, and injected with a discharge gas, and the resulting panel is aged to provide a plasma display panel.

### EXAMPLE 1

According to an embodiment of the invention, a binder solution is provided by adding 6 parts by weight of a binder of ethyl cellulose to 100 parts by weight of a mixed solvent of butyl carbitol acetate and terpineol (weight ratio: 4:6). 40 parts by weight of each of a blue phosphor of CaMgSi₂O₆:Eu, a red phosphor of (Y,Gd)BO₃:Eu, and a green phosphor of ZnSiO₄:Mn are added to the 100 parts by weight of the resulting binder solution and mixed, respectively, and coated inside of the discharge cells to provide phosphor layers. A layer for decreasing a reflective brightness is coated on the upper-end surface of the barrier rib of the first substrate.

The composition of the blue phosphor layer is the same as the composition of the layer for decreasing reflective brightness. In addition, the layer for decreasing reflective brightness is only coated on the upper-end surface of the barrier rib. The layer for decreasing a reflective brightness is controlled to be an average of 2 μm thick by adjusting a speed of the spray nozzle in motion over the upper-end surface of the barrier rib.

A display electrode 13, a dielectric layer 5, and a protection layer 17 are provided on a second substrate 11. The resulting first and second substrates 11 are associated, sealed, evaporated, and injected with a discharge gas, and the resulting panel is aged to provide a plasma display panel.

### EXAMPLE 2

According to another embodiment of the invention, a plasma display panel is fabricated in the same manner as described above in Example 1; however the layer for decreasing reflective brightness is formed to approximately 4 μm thick on the upper-end surface of the barrier rib of the first substrate.

### EXAMPLE 3

According to another embodiment of the invention, a plasma display panel is fabricated in the same manner as described above in Example 1; however, the layer for decreasing reflective brightness is formed to approximately 6 μm thick on the upper-end surface of the barrier rib of the first substrate.

### EXAMPLE 4

According to another embodiment of the invention, a plasma display panel is fabricated in the same manner as described above as described above in Example 1; however, the layer for decreasing reflective brightness is formed to approximately 8 μm thick on the upper-end surface of the barrier rib of the first substrate.

### EXAMPLE 5

According to another embodiment of the invention, a plasma display panel is fabricated in the same manner as described above in Example 1; however, the layer for decreasing reflective brightness is formed to approximately 10 μm thick on the upper-end surface of the barrier rib of the first substrate.

### EXAMPLE 6

According to another embodiment of the invention, a plasma display panel is fabricated in the same manner as described above in Example 1; however, the layer for decreasing reflective brightness is formed to approximately 12 μm thick on the upper-end surface of the barrier rib of the first substrate.

### EXAMPLE 7

According to another embodiment of the invention, a plasma display panel is fabricated in the same manner as described above in Example 1; however, the layer for decreasing reflective brightness is formed to approximately 14 μm thick on the upper-end surface of the barrier rib of the first substrate.

### Example 8

According to another embodiment of the invention, a plasma display panel is fabricated in the same manner as described above in Example 1; however, the layer for decreasing reflective brightness is formed to approximately 16 μm thick on the upper-end surface of the barrier rib of the first substrate.

### EXAMPLE 9

According to another embodiment of the invention, a plasma display panel is fabricated in the same manner as described above in Example 1; however, the layer for decreasing reflective brightness is formed to approximately 18 μm thick on the upper-end surface of the barrier rib of the first substrate.

### EXAMPLE 10

According to another embodiment of the invention, a plasma display panel is fabricated in the same manner as described above in Example 1; however, the layer for decreasing reflective brightness is formed to approximately 2 μm thick on the upper-end surface of the barrier rib of the first substrate, and the blue phosphor layer and the layer for decreasing a reflective brightness include CaMgSi₂O₆:Eu and BaMgAl₁₀O₁₇:Eu at a weight ratio of 5:5.

### EXAMPLE 11

According to another embodiment of the invention, a plasma display panel is fabricated in the same manner as described above in Example 10; however, the layer for decreasing reflective brightness is formed to approximately 4 μm thick on the upper-end surface of the barrier rib of the first substrate.

### EXAMPLE 12

According to another embodiment of the invention, a plasma display panel is fabricated in the same manner as described above in Example 10; however, the layer for decreasing reflective brightness is formed to approximately 6 μm thick on the upper-end surface of the barrier rib of the first substrate.

### EXAMPLE 13

According to another embodiment of the invention, a plasma display panel is fabricated in the same manner as described above in Example 10; however, the layer for decreasing reflective brightness is formed to approximately 8 μm thick on the upper-end surface of the barrier rib of the first substrate.

### EXAMPLE 14

According to another embodiment of the invention, a plasma display panel is fabricated in the same manner as described above in Example 10; however, the layer for decreasing reflective brightness is formed to approximately 10 μm thick on the upper-end surface of the barrier rib of the first substrate.

### EXAMPLE 15

According to another embodiment of the invention, a plasma display panel is fabricated in the same manner as described above in Example 10; however, that the layer for decreasing reflective brightness is formed to approximately 12 μm thick on the upper-end surface of the barrier rib of the first substrate.

### EXAMPLE 16

According to another embodiment of the invention, a plasma display panel is fabricated in the same manner as described above in Example 10; however, the layer for decreasing reflective brightness is formed to approximately 14 μm thick on the upper-end surface of the barrier rib of the first substrate.

### EXAMPLE 17

According to another embodiment of the invention, a plasma display panel is fabricated in the same manner as described above in Example 10; however, the layer for decreasing reflective brightness is formed to approximately 16 μm thick on the upper-end surface of the barrier rib of the first substrate.

### EXAMPLE 18

According to another embodiment of the invention, a plasma display panel is fabricated in the same manner as described above in Example 10; however, the layer for decreasing reflective brightness is formed to approximately 18 μm thick on the upper-end surface of the barrier rib of the first substrate.

### EXAMPLE 19

According to another embodiment of the invention, a plasma display panel is fabricated in the same manner as described above in Example 1; however, the layer for decreasing reflective brightness is formed to approximately 2 μm thick on the upper-end surface of the barrier rib of the first substrate, and the blue phosphor layer and the layer for decreasing a reflective brightness include CaMgSi₂O₆:Eu and BaMgAl₁₀O₁₇:Eu at a weight ratio of 7:3.

### EXAMPLE 20

According to another embodiment of the invention, a plasma display panel is fabricated in the same manner as described above in Example 19; however, the layer for decreasing reflective brightness is formed to approximately 4 μm thick on the upper-end surface of the barrier rib of the first substrate.

### EXAMPLE 21

According to another embodiment of the invention, a plasma display panel is fabricated in the same manner as described above in Example 19; however, the layer for decreasing reflective brightness is formed to approximately 6 μm thick on the upper-end surface of the barrier rib of the first substrate.

### EXAMPLE 22

According to another embodiment of the invention, a plasma display panel is fabricated in the same manner as described above in Example 19; however, the layer for decreasing reflective brightness is formed to approximately 8 μm thick on the upper-end surface of the barrier rib of the first substrate.

### EXAMPLE 23

According to another embodiment of the invention, a plasma display panel is fabricated in the same manner as described above in Example 19; however, the layer for decreasing reflective brightness is formed to approximately 10 μm thick on the upper-end surface of the barrier rib of the first substrate.

### EXAMPLE 24

According to another embodiment of the invention, a plasma display panel is fabricated in the same manner as described above in Example 19; however, the layer for decreasing reflective brightness is formed to approximately 12 μm thick on the upper-end surface of the barrier rib of the first substrate.

### EXAMPLE 25

According to another embodiment of the invention, a plasma display panel is fabricated in the same manner as described above in Example 19; however, the layer for decreasing reflective brightness is formed to approximately 14 μm thick on the upper-end surface of the barrier rib of the first substrate.

### EXAMPLE 26

According to another embodiment of the invention, a plasma display panel is fabricated in the same manner as described above in Example 19; however, the layer for decreasing reflective brightness is formed to approximately 16 μm thick on the upper-end surface of the barrier rib of the first substrate.

### EXAMPLE 27

According to another embodiment of the invention, a plasma display panel is fabricated in the same manner as described above in Example 19; however, the layer for decreasing reflective brightness is formed to approximately 18 μm thick on the upper-end surface of the barrier rib of the first substrate.

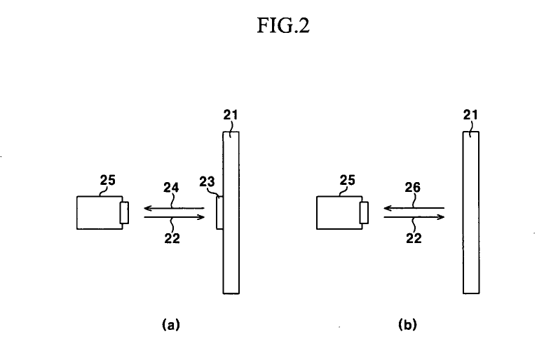

The embodiments of the plasma display panels described above with reference to Comparative Example 1 and Examples 1 through 27 were each measured for reflective brightness. FIG. 2 is a schematic diagram showing a process for measuring the reflective brightness of the plasma display panel, as was used to measure the reflective brightness of Comparative Example 1 and Examples 1 through 27. The following procedure may change according to various methods and/or design specifications and is not limited to testing procedure discussed below.

Referring to FIG. 2, the reflective brightness of Comparative Example 1 and Examples 1 through 27 were measured by attaching a light reflection plate 23 to a center area of the off-state plasma display panel 21. The brightness detector 25 or calorimeter (for example, a TOPCON BM7) was positioned facing a front surface of the light reflection plate 23. The brightness detector 25 emitted incident light 22 to the panel at a brightness of approximately 42 cd/m² of the reflective light 24 reflected from the light reflection plate 23. The light reflection plate 23 was subsequently removed and the incident light 22 was applied to the panel to measure the brightness of the reflection light 26 reflecting from the panel.

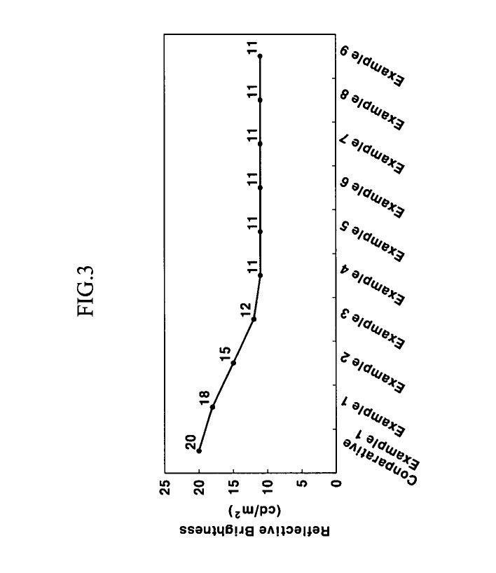

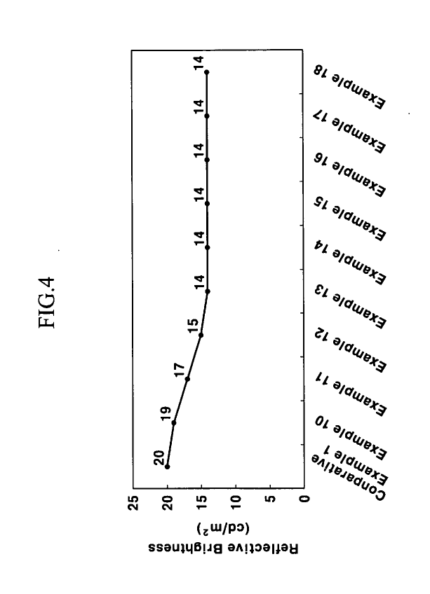

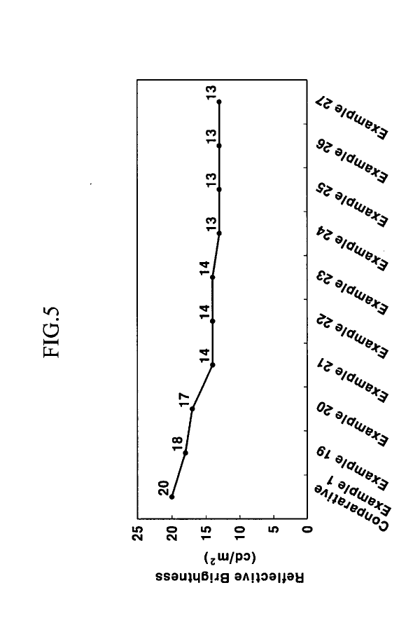

FIG. 3 is a graph comparing the reflective brightness upon changing the thickness of the layer for decreasing the reflective brightness of the plasma display panel according to Comparative Example 1 and Examples 1 through 9. Similarly, FIG. 4 is a graph comparing the reflective brightness upon changing the thickness of the layer for decreasing the reflective brightness of the plasma display panel according to Comparative Example 1 and Examples 10 through 18. FIG. 5 is a graph comparing the reflective brightness upon changing the thickness of the layer for decreasing the reflective brightness of the plasma display panel according to Comparative Example 1 and Examples 19 through 27.

As shown in FIGS. 3, 4 and 5, the plasma display panels of the present invention having a layer for decreasing the reflective brightness decrease the reflective brightness of the plasma display panel. Specifically, the reflective brightness decreases by at least 20% when the thickness of the layer for decreasing the reflective brightness is at least approximately 6 μm.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel comprising:
a first substrate having a plurality of address electrodes and a dielectric layer;
a second substrate facing the first substrate and having a plurality of display electrodes, a dielectric layer, and a protection layer;
barrier ribs formed on the first substrate to partition a plurality of discharge cells between the first substrate and the second substrate;
a red phosphor layer, a green phosphor layer, and a blue phosphor layer formed inside of each discharge cell partitioned by the barrier ribs; and
a layer for decreasing reflective brightness,
wherein the layer is formed on the upper-end surface of the barrier ribs, and comprises calcium magnesium silicate based blue phosphor.

2. The plasma display panel of claim 1, wherein the barrier ribs are closed-type barrier ribs.

3. The plasma display panel of claim 2, wherein the layer for decreasing reflective brightness is provided on an upper-end surface of barrier ribs arranged substantially perpendicular to the address electrodes.

4. The plasma display panel of claim 3, wherein the layer for decreasing reflective brightness is provided on the upper-end surface of the barrier ribs positioned between blue cells and arranged substantially perpendicular to the address electrodes.

5. The plasma display panel of claim 1, wherein the layer for decreasing reflective brightness is provided on an upper-end surface of the barrier ribsto approximately between 2 and 20 μm thick.

6. The plasma display panel of claim 5, wherein the layer for decreasing reflective brightness is provided on the upper-end surface of the barrier ribsto approximately between 6 and 20 μm thick.

7. The plasma display panel of claim 1, wherein the layer for decreasing reflective brightness comprises approximately 50 to 100% by weight of calcium magnesium silicate based blue phosphor.

8. The plasma display panel of claim 7, wherein the layer for decreasing reflective brightness further comprises a barium magnesium aluminate based blue phosphor.

9. The plasma display panel of claim 1, wherein a composition of the blue phosphor layer formed inside the discharge cell partitioned by the barrier ribs and a composition of the layer for decreasing a reflective brightness coated on the upper-end surface of the barrier rib are the same.

10. The plasma display panel according to claim 1, wherein the upper-end surface of the barrier ribs is a surface nearest to the second substrate.

11. A method for fabricating a plasma display panel, comprising:
preparing a first substrate formed having a plurality of address electrodes and a dielectric layer;
forming barrier ribs on the front surface of the dielectric layer of the first substrate to partition a plurality of discharge cells;
forming a red phosphor layer, a green phosphor layer, and a blue phosphor layer inside of each discharge cell partitioned by the barrier ribs;
forming a layer for decreasing reflective brightness on an upper-end of the barrier ribs;
preparing a second substrate having a display electrodes, a dielectric layer, and a protection layer; and
associating a panel with the first substrate and the second substrate and performing fabrication processes with the panel associated with the first substrate and the second substrates.

12. The method of claim 11, wherein the barrier ribs are closed-type barrier ribs.

13. The method of claim 12, wherein the layer for decreasing reflective brightness is provided on the upper-end surface of barrier ribs arranged in substantially perpendicular to the address electrodes.

14. The method of claim 13, wherein the layer for decreasing reflective brightness is provided on the upper-end surface of the barrier ribs positioned between blue cells and arranged substantially perpendicular to the address electrodes.

15. The method of claim 11, wherein the phosphor layer and the layer for decreasing reflective brightness are respectively formed using a dispenser technique.

16. The method of claim 15, further comprising:
forming the blue phosphor layer by applying the same composition as that of the layer for decreasing reflective brightness using a dispenser technique.

17. The method of claim 11, further comprising:
evacuating and injecting a discharge gas into the panel associated with the first and second substrates;
sealing the panel; and
aging the panel.
